(19) United States
(12) Patent Application Publication
(10) Pub. No.: US 2024/0331915 A1
(43) Pub. Date: Oct. 3, 2024

(54) REACTOR

(71) Applicant: HONDA MOTOR CO., LTD., Tokyo (JP)

(72) Inventor: Takanori SAKAGUCHI, Saitama (JP)

(21) Appl. No.: 18/583,881

(22) Filed: Feb. 22, 2024

(30) Foreign Application Priority Data
Mar. 27, 2023 (JP) 2023-049759

(51) Int. Cl. H01F 27/10; H01F 27/24; H01F 27/28

(52) U.S. Cl. CPC H01F 27/10; H01F 27/24; H01F 27/28

(57) ABSTRACT

The objective is to efficiently suppress the temperature of the hottest parts within the core and within each coil. The reactor includes a magnetic core having an annular shape, a primary coil unit externally fitted on the core, and a secondary coil unit externally fitted on the core. The primary coil unit includes a primary coil and a primary-side coating that coats the primary coil. The secondary coil unit includes a secondary coil and a secondary-side coating that coats the secondary coil. The reactor further includes a cooling container. The cooling container houses the core, the primary coil unit, and the secondary coil unit. Within the cooling container, a liquid coolant flows from an inlet towards an outlet in such that the liquid level of the coolant is higher than the upper ends of all of the core, the primary coil, and the secondary coil.

This application is based on and claims the benefit of priority from Japanese Patent Application No. 2023-049759, filed on 27 Mar. 2023, the content of which is incorporated herein by reference.

### BACKGROUND OF THE INVENTION

### Field of the Invention

The present invention relates to a reactor that includes a core having an annular shape and a plurality of coil units externally fitted on the core.

### Related Art

Some reactors are configured such that the lower part of the core and the lower part of each coil unit are cooled by being immersed in a coolant.
Patent Document 1: Japanese Unexamined Patent Application, Publication No. 2021-77814

### SUMMARY OF THE INVENTION

However, the inventors have focused on the following points. The temperature of the hottest parts within the core and each coil should desirably be kept below a predetermined temperature. In the above configuration, although the lower part of the core and the lower part of each coil can be sufficiently cooled by being immersed in the coolant, the upper part of the core and the upper part of each coil cannot be sufficiently cooled. Therefore, a temperature disparity arises within the core and each coil. Thus, the temperature of the hottest parts within the core and each coil cannot be efficiently suppressed.

The present invention has been made in view of the above circumstances with an object to efficiently suppress the temperature of the hottest parts within the core and within each coil.

The inventors have arrived at the present invention by recognizing that the above object can be achieved by immersing the core and each coil up to their upper ends in the coolant. The present invention is a reactor with the following configurations (1) to (7):
(1) A reactor that includes: a magnetic core having an annular shape; a primary coil unit externally fitted on the core; and a secondary coil unit externally fitted on the core, in which
the primary coil unit includes a primary coil and a primary-side coating that coats the primary coil, the secondary coil unit includes a secondary coil and a secondary-side coating that coats the secondary coil, the reactor further includes a cooling container that houses the core, the primary coil unit, and the secondary coil unit, and that has an inlet and an outlet formed therein, and inside the cooling container, a liquid coolant flows from the inlet towards the outlet such that the liquid level of the coolant is higher than the upper ends of all of the core, the primary coil, and the secondary coil.

With this configuration, since each coil is coated, there is no risk of short-circuiting even when each coil is immersed in the coolant. In this state, the liquid coolant flows inside the cooling container such that the liquid level of the coolant is higher than the upper ends of all of the core and each coil. This ensures that the core and each coil, which constantly generate heat during the operation of the reactor, are completely immersed in the coolant and uniformly cooled. This allows for reducing the temperature disparity within the core and the temperature disparity within each coil, efficiently suppressing the temperature of the hottest parts.
(2) The reactor as described above in (1), in which the lower end of the outlet is located above the upper ends of all of the core, the primary coil, and the secondary coil.

This configuration allows for easily and reliably controlling the coolant to flow, ensuring that the liquid level of the coolant is higher than the upper ends of all of the core and each coil.
(3) The reactor as described above in (2), in which the inlet and the outlet are provided in an upper surface of the cooling container.

With this configuration, the inlet is provided in the upper surface of the cooling container, thus the coolant inside the cooling container can be less likely to flow back to the inlet. Furthermore, the outlet is also located in the upper surface of the cooling container, thus only the excess amount of the coolant overflowing from the cooling container can be efficiently discharged from the cooling container. Therefore, the coolant can flow while the entirety of the core and the entirety of each coil are efficiently immersed in the coolant.
(4) The reactor as described above in (3), in which the cooling container includes: a container body that encloses the core, the primary coil unit, and the secondary coil unit from the surrounding in the horizontal direction and from below; and a lid attached to the upper end of the container body, in which the inlet and the outlet are provided in the lid.

This configuration allows for simply implementing the configuration (3).
(5) The reactor as described above in (4), in which a primary-side first terminal, a primary-side second terminal, a secondary-side first terminal, and a secondary-side second terminal are provided in the bottom surface of the container body,
the primary-side first terminal is electrically connected to one end of the primary coil via a primary-side first wiring, the primary-side second terminal is electrically connected to the other end of the primary coil via a primary-side second wiring,
the secondary-side first terminal is electrically connected to one end of the secondary coil via a secondary-side first wiring,
the secondary-side second terminal is electrically connected to the other end of the secondary coil via a secondary-side second wiring,
the primary-side coating coats the primary-side first wiring and the primary-side second wiring, in addition to the primary coil, and
the secondary-side coating coats the secondary-side first wiring and the secondary-side second wiring, in addition to the secondary coil.

With this configuration, in which the lid includes the inlet and the outlet as described in (4), the four terminals are provided in the bottom surface of the container body. Therefore, the inlet and the outlet, as well as the four terminals, can be vertically distributed in a well-balanced manner. Moreover, the primary-side coating coats the two wirings on the primary side, and the secondary-side coating coats the two wirings on the secondary side. Therefore, there is no risk of short-circuiting due to the wirings coming into contact with the coolant.
(6) The reactor as described above in any one of (1) to (5), in which the core is attached to the cooling container via a mounting member, and
the mounting member includes a through-hole-shaped exposure hole that exposes the core and increases surfaces of the core exposed to the coolant.

With this configuration, while the core is attached to the cooling container using the mounting member, the exposure holes can prevent the cooling effect on the core from being hindered by the mounting member.
(7) The reactor as described above in (6), in which the exposure hole includes: a top surface exposure hole that exposes the top surface of the core; a side surface exposure hole that exposes a horizontal side surface of the core; and a bottom surface exposure hole that exposes a bottom surface of the core.

With this configuration, the top surface, the horizontal side surfaces, and the bottom surface of the core are exposed, thus the core can be more uniformly cooled.

As described above, with the configuration (1), the temperature of the hottest parts within the core and within each coil can be efficiently suppressed. Furthermore, the configurations (2) to (7), which reference (1), each achieve additional effects.

### BRIEF DESCRIPTION OF THE DRAWINGS

FIG. 1 is an exploded perspective view illustrating a reactor of the first embodiment;

FIG. 2 is an exploded perspective view illustrating the lower part of the reactor;

FIG. 3 is an exploded perspective view illustrating an interior of the reactor;

FIG. 4 is a front view illustrating a primary core unit and a secondary coil unit;

FIG. 5 is a perspective view of the interior of the reactor, viewed upside down;

FIG. 6 is a perspective view of the primary coil unit, viewed from an angle different from FIG. 5;

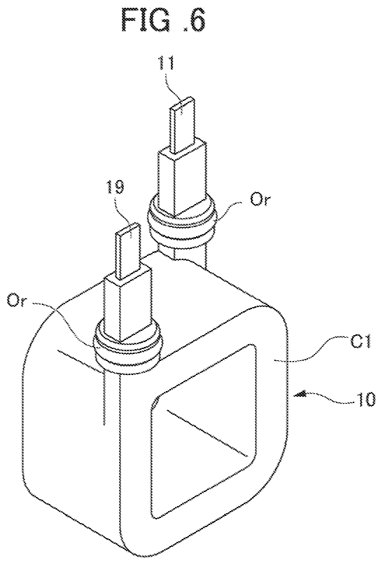

FIG. 7 is a perspective view illustrating a cross-section of part of the primary coil unit;

FIG. 8 is a plan view illustrating the reactor;

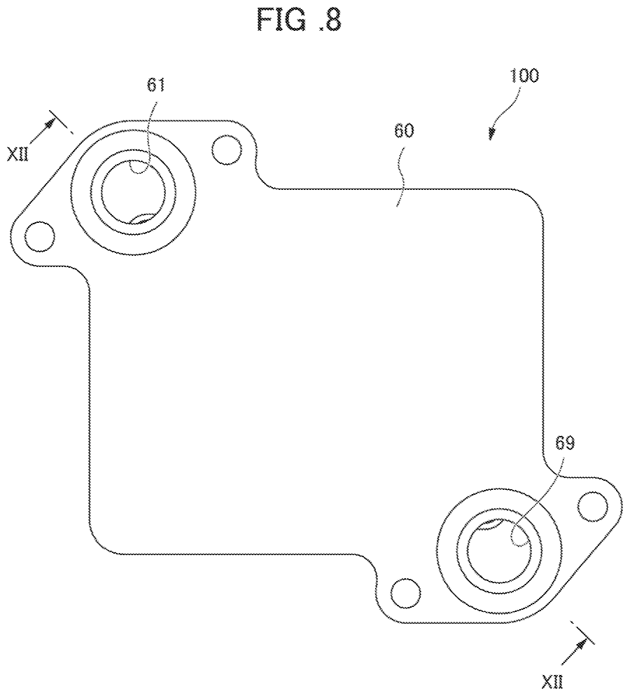

FIG. 9 is a plan view illustrating the reactor with its lid removed;

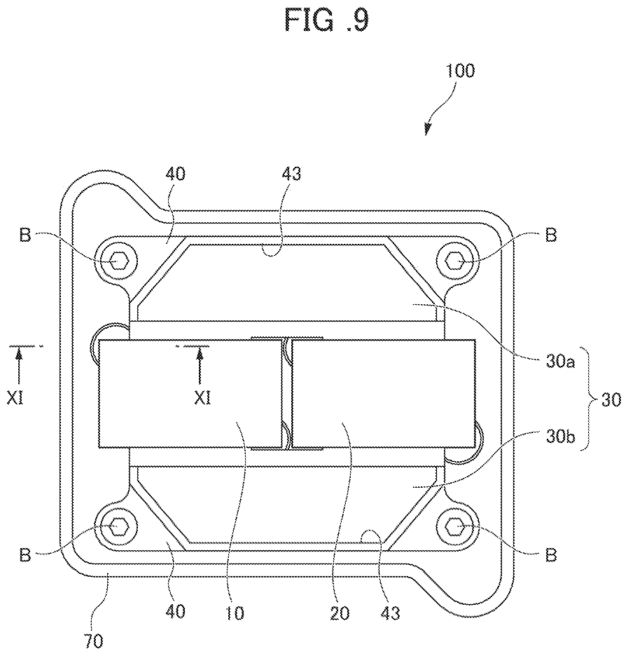

FIG. 10 is a front view of the reactor;

FIG. 11 is a view illustrating a cross-section along the line XI-XI in FIG. 9; and

FIG. 12 is a view illustrating a cross-section along the line XII-XII in FIG. 8.

### DETAILED DESCRIPTION OF THE INVENTION

Hereinafter, embodiments of the present invention will be described with reference to the drawings. However, the present invention is not limited to the following embodiments and can be implemented with appropriate modifications within the scope that does not deviate from the spirit of the invention.

### First Embodiment

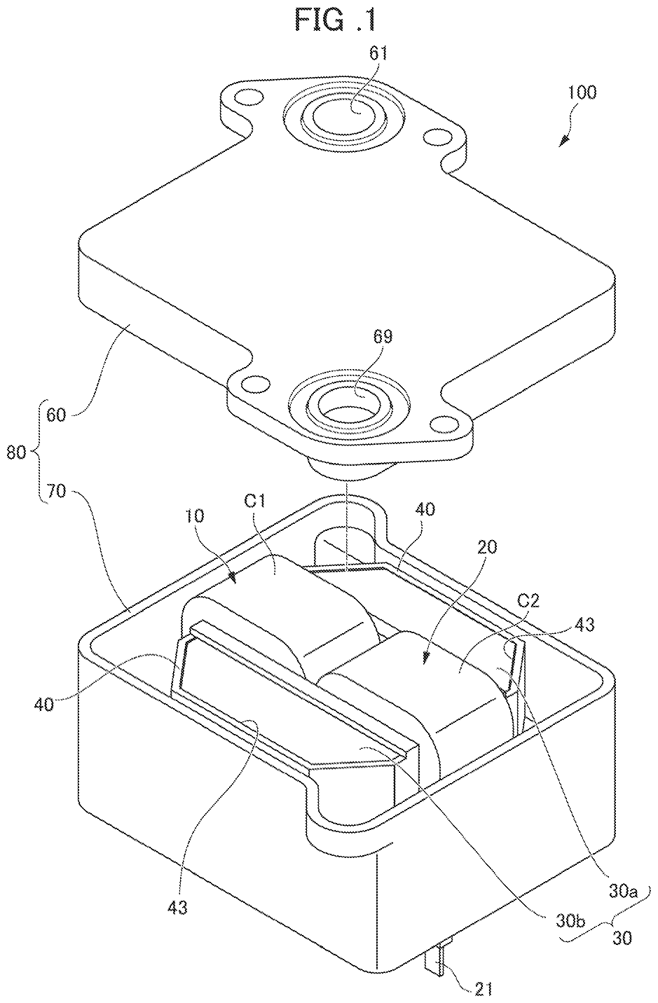

As illustrated in FIG. 1, a reactor 100 of the present embodiment includes a core 30, a primary coil unit 10, a secondary coil unit 20, and a cooling container 80.

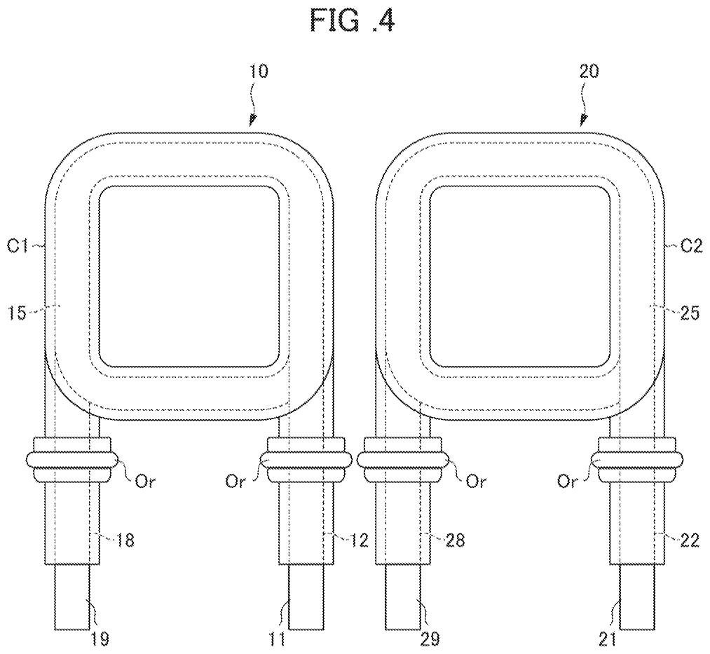

As illustrated in FIG. 4, the primary coil unit 10 includes a primary-side first terminal 11, a primary-side first wiring 12, a primary coil 15, a primary-side second wiring 18, a primary-side second terminal 19, and a primary-side coating C1. Specifically, the wound portion of the single wire constitutes the primary coil 15, and the portions protruding from both ends of the primary coil 15 constitute the primary-side first wiring 12 and primary-side second wiring 18.

The end of the primary-side first wiring 12 opposite to the primary coil 15 constitutes the primary-side first terminal 11, and the end of the primary-side second wiring 18 opposite to the primary coil 15 constitutes the primary-side second terminal 19. In other words, the primary-side first wiring 12 electrically connects the primary-side first terminal 11 to one end of the primary coil 15, and the primary-side second wiring 18 electrically connects the other end of the primary coil 15 to the primary-side second terminal 19.

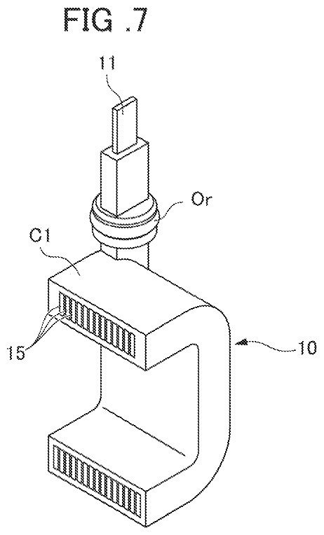

The primary-side coating C1, made of resin or similar material, not only coats and waterproofs the primary coil 15 as illustrated in FIG. 7, but also coats and waterproofs the primary-side first wiring 12 and the primary-side second wiring 18 as illustrated in FIG. 4.

The secondary coil unit 20 includes a secondary-side first terminal 21, a secondary-side first wiring 22, a secondary coil 25, a secondary-side second wiring 28, a secondary-side second terminal 29, and a secondary-side coating C2. The description of the secondary coil unit 20 is similar to that of the primary coil unit 10, with “primary” replaced by “secondary” and the symbols correspondingly adjusted.

Hereinafter, the primary-side first wiring 12, the primary-side second wiring 18, the secondary-side first wiring 22, and the secondary-side second wiring 28 are collectively referred to as “the four wirings 12, 18, 22, 28”. Similarly, the primary-side first terminal 11, the primary-side second terminal 19, the secondary-side first terminal 21, and the secondary-side second terminal 29 are collectively referred to as “the four terminals 11, 19, 21, 29”.

Furthermore, the primary coil unit 10 and the secondary coil unit 20 are collectively referred to as “each coil unit 10, 20”. The primary coil 15 and the secondary coil 25 are collectively referred to as “each coil 15, 25”. The primary-side coating C1 and the secondary-side coating C2 are collectively simply referred to as “the coatings C1, C2”.

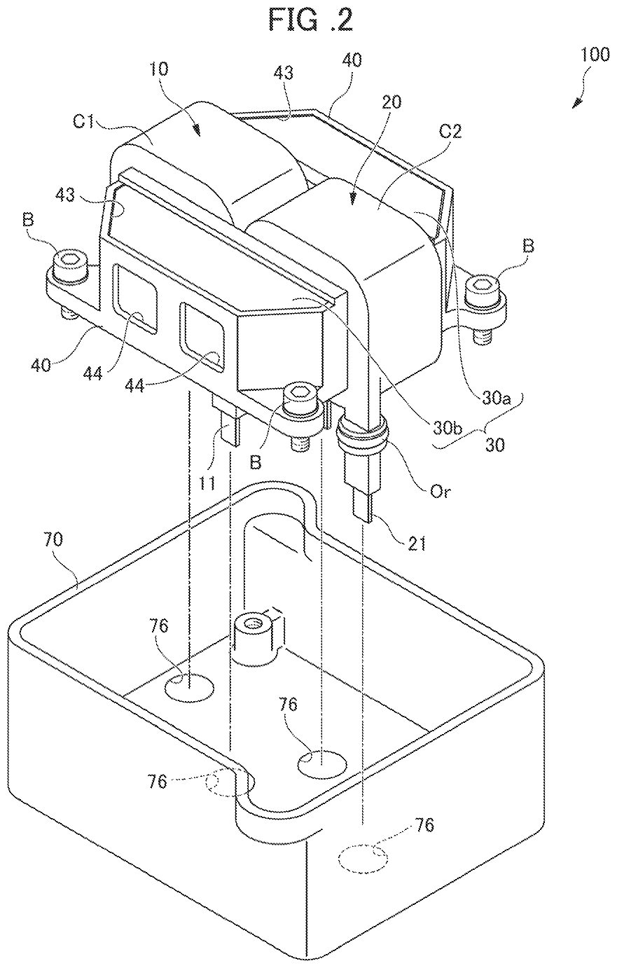

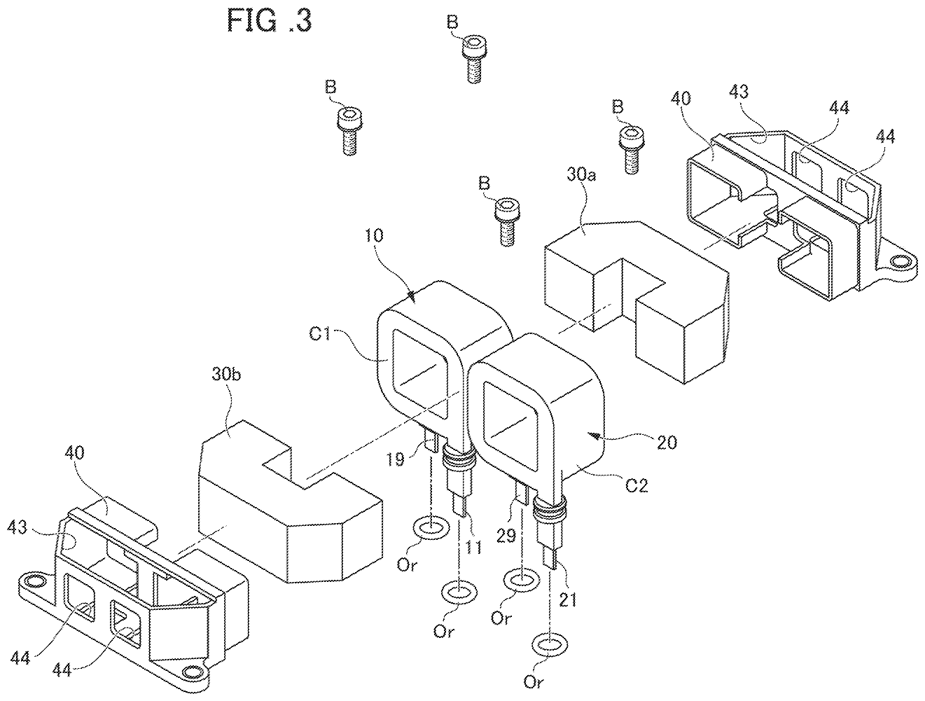

As illustrated in FIG. 3, the core 30 is divided into a semi-circular first core part 30a and a semi-circular second core part 30b. Both the first core part 30a and the second core part 30b are made of a magnetic material such as metal. One end of the first core part 30a contacts one end of the second core part 30b inside the primary coil unit 10. The other end of the first core part 30a contacts the other end of the second core part 30b inside the secondary coil unit 20. As illustrated in FIG. 2, with this configuration, the primary coil unit 10 and the secondary coil unit 20 are externally fitted on the core 30.

As illustrated in FIG. 1, the cooling container 80 is a container designed to house the core 30, the primary coil unit 10, and the secondary coil unit 20, and includes a container body 70 and a lid 60. The container body 70 and the lid 60 may be made of metal such as aluminum, or may be made of a resin material. The container body 70 is box-shaped with an open top, and encloses the core 30 and each coil unit 10, 20 from the surrounding in the horizontal direction and from below. The lid 60 is attached to the upper end of the container body 70.

As illustrated in FIG. 1, the lid 60 includes an inlet 61 and an outlet 69, both penetrating vertically. The inlet 61 is a portion that allows the liquid coolant Rf to flow into the cooling container 80. The outlet 69 is a portion that allows the coolant Rf within the cooling container 80 to flow out. The coolant Rf may be water or various other liquids with better cooling efficiency than water.

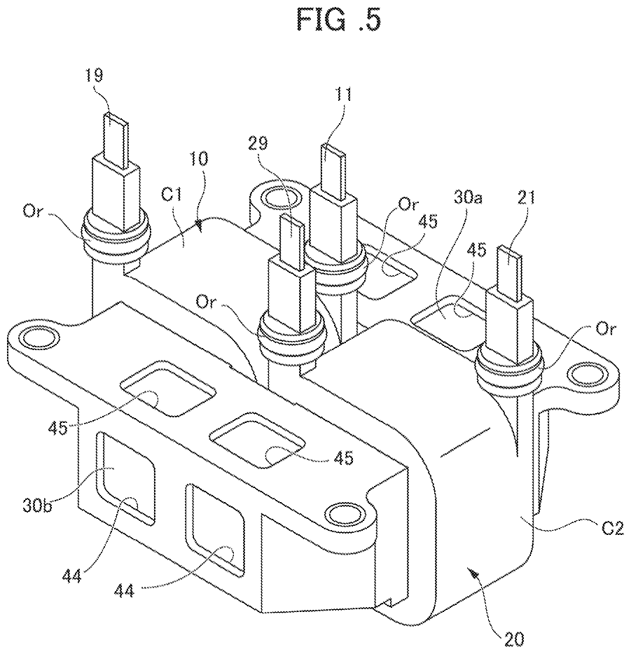

As illustrated in FIG. 2, the core 30 is attached to the bottom surface of the container body 70 via a mounting member 40, using bolts B or similar. The mounting member 40 includes a plurality of through-hole-shaped exposure holes 43, 44, 45, which expose the core 30 and increase the surface of the core 30 exposed to the coolant Rf. Specifically, the exposure holes 43, 44, 45 include top surface exposure holes 43 that expose the top surface of the core 30, and side surface exposure holes 44 that expose the horizontal side surfaces of the core 30 as illustrated in FIG. 2, as well as bottom surface exposure holes 45 that expose the bottom surface of the core 30 as illustrated in FIG. 5.

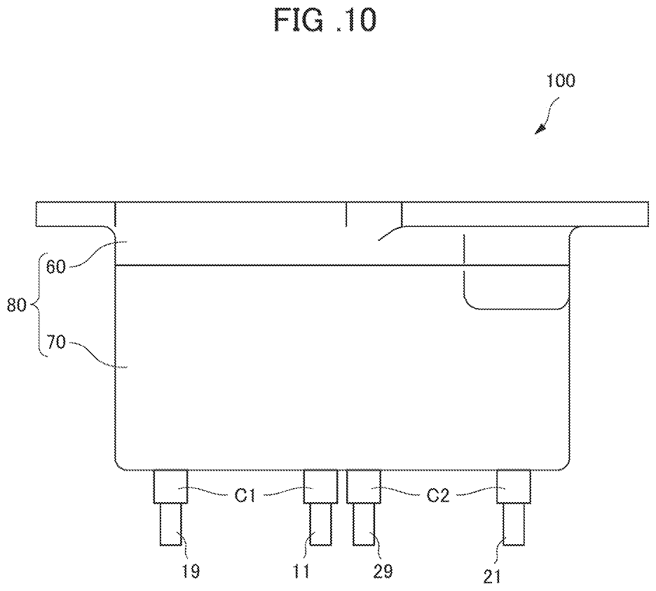

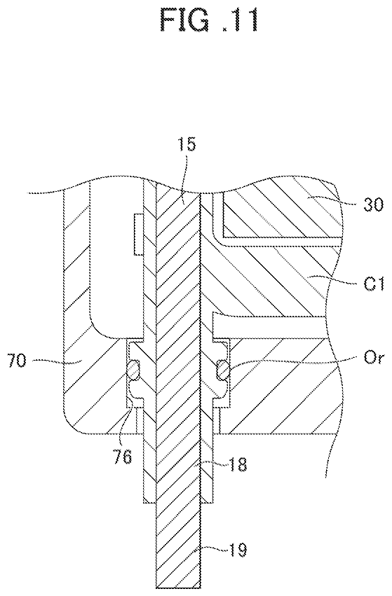

As illustrated in FIG. 2, the bottom surface of the container body 70 includes four through-holes 76 designed to insert the four wirings 12, 18, 22, 28, respectively. As illustrated in FIG. 4, O-rings Or are externally fitted on the portions of the coatings C1, C2 covering the four wirings 12, 18, 22, 28. As illustrated in FIG. 2, portions of the four O-rings Or in the coil units 10, 20 pass through the through-holes 76. As a result, as illustrated in FIG. 10, the four terminals 11, 19, 21, 29 are arranged in the bottom surface of the container body 70. At this time, as illustrated in FIG. 11, the O-rings Or ensure the sealing between the coatings C1, C2 and the inner surfaces of the through-holes 76.

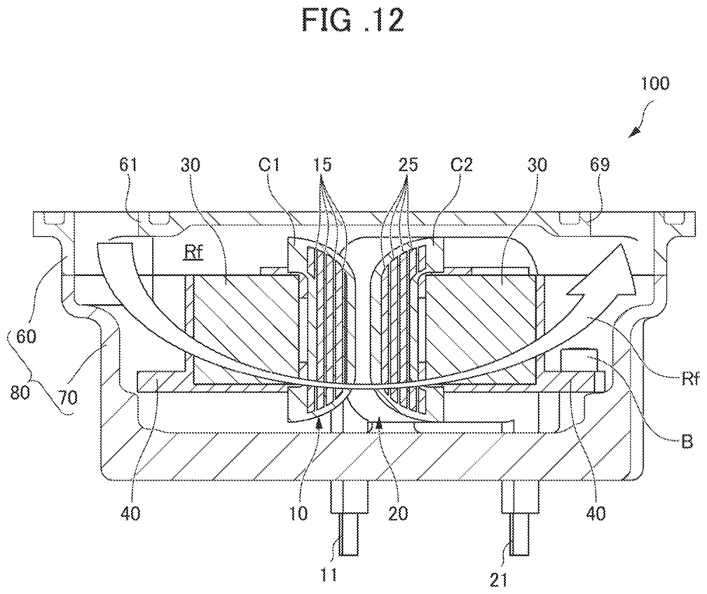

As illustrated in FIG. 12, during the operation of the reactor 100, the coolant Rf flows inside the cooling container 80 from the inlet 61 towards the outlet 69. At this time, since the outlet 69 is located above the upper ends of all of the core 30 and each coil unit 10, 20, the coolant Rf flows such that the liquid level of the coolant Rf is inevitably higher than the upper ends of all of the core and each coil unit.

The configuration and effects of the present embodiment are summarized below.

As illustrated in FIG. 4, since each coil 15, 25 is coated with the coating C1, C2, there is no risk of short-circuiting even when the coil 15, 25 is immersed in the coolant Rf. In this state, as illustrated in FIG. 12, the coolant Rf flows inside the cooling container 80 such that the liquid level of the coolant Rf is higher than the upper ends of all of the core 30 and each coil 15, 25. This ensures that the core 30 and each coil 15, 25, which constantly generate heat during the operation of the reactor 100, are entirely immersed in the coolant Rf and uniformly cooled. This allows for reducing the temperature disparity within the core 30 and the temperature disparity within each coil 15, 25, efficiently suppressing the temperature of the hottest parts.

As illustrated in FIG. 12, the lower end of the outlet 69 is positioned above the upper ends of all of the core 30 and each coil 15, 25. This configuration allows for easily and reliably controlling the coolant Rf to flow, ensuring that the liquid level of the coolant Rf is higher than the upper ends of all of the core 30 and each coil 15, 25.

The inlet 61 is provided in the upper surface of the cooling container 80. As a result, the coolant Rf inside the cooling container 80 can be less likely to flow back to the inlet 61. Similarly, the outlet 69 is also located in the upper surface of the cooling container 80. As a result, only the excess amount of the coolant Rf overflowing from the cooling container 80 can be efficiently discharged from the cooling container 80. Thus, the coolant Rf can flow while the entirety of the core 30 and the entirety of each coil 15 are efficiently immersed in the coolant Rf.

As illustrated in FIG. 12, the cooling container 80 includes the container body 70 and the lid 60, in which the inlet 61 and the outlet 69 are provided in the lid 60. As a result, the inlet 61 and the outlet 69 can be easily provided in the upper surface of the cooling container 80.

With this configuration in which the inlet 61 and the outlet 69 are provided in the lid 60, as illustrated in FIG. 10, the four terminals 11, 19, 21, 29 are provided in the bottom surface of the container body 70. Therefore, as illustrated in FIG. 12, the inlet 61, the outlet 69, and the four terminals 11, 19, 21, 29 can be vertically distributed in a well-balanced manner. Moreover, as illustrated in FIG. 4, the primary-side coating C1 coats the primary-side first wiring 12 and the primary-side second wiring 18, in addition to the primary coil 15. Similarly, the secondary-side coating C2 coats the secondary-side first wiring 22 and the secondary-side second wiring 28, in addition to the secondary coil 25. Therefore, there is no risk of short-circuiting due to the four wirings 12, 18, 22, 28 coming into contact with the coolant Rf.

As illustrated in FIG. 2, the core 30 is attached to the cooling container 80 via the mounting member 40. The mounting member 40 includes the exposure holes 43, 44, 45, which expose the core 30 and increase the surface of the core 30 exposed to the coolant Rf. Therefore, while the core 30 is attached to the cooling container 80 using the mounting member 40, the exposure holes 43, 44, 45 can prevent the cooling effect on the core 30 from being hindered by the mounting member 40.

The exposure holes 43, 44, 45 include the top surface exposure hole 43 and the side surface exposure hole 44 as illustrated in FIG. 2, as well as the bottom surface exposure hole 45 as illustrated in FIG. 5. These holes expose the top surface, the horizontal side surfaces, and the bottom surface of the core 30, thus the core 30 can be more uniformly cooled.

### Other Embodiments

The embodiment described above can be modified, for example, in the following manner. For example, one or both of the inlet 61 and the outlet 69 illustrated in FIG. 1 may be provided in the side or bottom of the container body 70. Some or all of the four terminals 11, 19, 21, 29 illustrated in FIG. 10 may be provided in the side of the container body 70 or on the upper surface of the lid 60. The reactor 100 illustrated in FIG. 2 may have a plurality of annular shapes. In addition to the primary coil unit 10 and the secondary coil unit 20 illustrated in FIG. 2, a third coil unit may also be externally fitted on the core 30.

### EXPLANATION OF REFERENCE NUMERALS

10: primary coil unit
11: primary-side first terminal
12: primary-side first wiring
15: primary coil
18: primary-side second wiring
19: primary-side second terminal
20: secondary coil unit
21: secondary-side first terminal
22: secondary-side first wiring
25: secondary coil
28: secondary-side second wiring
29: secondary-side second terminal
30: core
40: mounting member
43: top surface exposure hole
44: side surface exposure hole
45: bottom surface exposure hole
60: lid
61: inlet
69: outlet
70: container body
80: cooling container
100: reactor
C1: primary-side coating
C2: secondary-side coating
Rf: coolant

What is claimed is:

1. A reactor comprising:
a magnetic core having an annular shape;
a primary coil unit externally fitted on the core; and
a secondary coil unit externally fitted on the core, wherein
the primary coil unit includes a primary coil and a primary-side coating that coats the primary coil,
the secondary coil unit includes a secondary coil and a secondary-side coating that coats the secondary coil,
the reactor further comprises a cooling container that houses the core, the primary coil unit, and the secondary coil unit, and that has an inlet and an outlet formed therein, and
within the cooling container, a liquid coolant flows from the inlet towards the outlet such that a liquid level of the coolant is higher than upper ends of all of the core, the primary coil, and the secondary coil.

2. The reactor according to claim 1, wherein
the lower end of the outlet is located above the upper ends of all of the core, the primary coil, and the secondary coil.

3. The reactor according to claim 2, wherein
the inlet and the outlet are provided in an upper surface of the cooling container.

4. The reactor according to claim 3, wherein
the cooling container includes: a container body that encloses the core, the primary coil unit, and the secondary coil unit from a surrounding in a horizontal direction and from below; and a lid attached to the upper end of the container body, and
the inlet and the outlet are provided in the lid.

5. The reactor according to claim 4, wherein
a primary-side first terminal, a primary-side second terminal, a secondary-side first terminal, and a secondary-side second terminal are provided in a bottom surface of the container body,
the primary-side first terminal is electrically connected to one end of the primary coil via a primary-side first wiring,
the primary-side second terminal is electrically connected to the other end of the primary coil via a primary-side second wiring,
the secondary-side first terminal is electrically connected to one end of the secondary coil via a secondary-side first wiring,
the secondary-side second terminal is electrically connected to the other end of the secondary coil via a secondary-side second wiring,
the primary-side coating coats the primary-side first wiring and the primary-side second wiring, in addition to the primary coil, and
the secondary-side coating coats the secondary-side first wiring and the secondary-side second wiring, in addition to the secondary coil.

6. The reactor according to claim 1, wherein
the core is attached to the cooling container via a mounting member, and
the mounting member includes a through-hole-shaped exposure hole that exposes the core and increases surfaces of the core exposed to the coolant.

7. The reactor according to claim 6, wherein the exposure hole includes: a top surface exposure hole that exposes a top surface of the core; a side surface exposure hole that exposes a horizontal side surface of the core; and a bottom surface exposure hole that exposes a bottom surface of the core.
